(19) United States
(12) Patent Application Publication
(10) Pub. No.: US 2008/0215569 A1
(43) Pub. Date: Sep. 4, 2008

(54) Ad Placement Method with Frequency Component

(76) Inventors: Danial Moore, Covington, GA (US); Naima Moore, Covington, GA (US)

Correspondence Address: QUICKPATENTS, INC., 32861 CALLE PERFECTO, SUITE A, SAN JUAN CAPISTRANO, CA, 92675, US

(21) Appl. No.: 11/966,182

(22) Filed: Dec. 28, 2007

Related U.S. Application Data
(60) Provisional application No. 60/883,151, filed on Jan. 2, 2007.

(51) Int. Cl. G06F 7/10; G06F 17/30

(52) U.S. Cl. 707/5; 707/E17.017

(57) ABSTRACT

A method of generating a search result list in response to a search request from a client using a computer network is described. The search request is received, and a set of network addresses associated with search terms that match the search request is identified, each network address being associated with a modifiable bid value and a position value initially set to the bid value. The set is ordered according to the respective position values of the matching network addresses, and divided into a display set sent to the client and an excluded set. The position value of the network addresses in the display set is reset to its respective bid amount, and the position values of the network addresses in the excluded set are incremented by an increment factor I determined using the bid amount of the network address having the lowest position value of the display set.

### CROSS-REFERENCE TO RELATED APPLICATIONS

This application claims the benefit of U.S. Provisional Patent Application 60/883,151, filed on Jan. 2, 2007, and incorporated herein by reference.

### STATEMENT REGARDING FEDERALLY SPONSORED RESEARCH AND DEVELOPMENT

Not Applicable.

### FIELD OF THE INVENTION

This invention relates to ad-placement algorithms, and more particularly to an improved method that alters the frequency ads are displayed based on ad bids.

### DISCUSSION OF RELATED ART

Selling online advertising can be a major source of revenue for search engine websites. Advertisements, generally including web links to the web sites of network information providers, can be presented that relate to a search query entered by a user of the search engine. The advertisements, which can be in the form of banner advertisements, for example, can be displayed in the margins or bottom of the page displaying a set of search results.

The number of advertisements that can be presented can be limited due to a variety of factors (e.g., because of size limitations caused by the screen size, a desire to limit the number of advertisements due to aesthetic or speed concerns, etc.). In conventional search engines, the advertising space can be sold to network information providers. The network information providers can submit a bid amount (e.g., the amount of money the network information provider is willing to pay per retrieval request made by a client) and a search term associated with the bid amount. A retrieval request can be a request by the client to load the network address of the network information provider, and can take the form of clicking on a banner ad or a web link to the web site of the network information provider.

Because the number of advertisements is limited, advertising space generally is awarded to the network information providers who pay the highest bid amount. This can lead to a reduced number of network information providers willing to pay for advertisements, thereby reducing the amount of potential revenue for the search engine web site. Moreover, those ads with a lower bid amount may never get a chance to be displayed, reducing the effectiveness of such advertising for those advertisers unable to pay for the top positions. Furthermore, users may be exposed to advertisements that are less relevant to their search queries when the position of such ads are based purely on bid amounts, thereby reducing the likelihood that the users will click on any of the advertisements.

Methods of ad placement in search engines are known in the art. For example, U.S. App. No. 200702605088 to Barry et al. published on Nov. 8, 2007 describes methods and systems for providing advertisements over the internet by providing a hierarchical content-specific node structure and pricing advertising delivery over each node independently. Such an interface does not provide an algorithm for providing a dynamic list of advertisements that are responsive to a search query. The user is therefore limited to viewing advertisements from the network information providers that pay the highest bid amount, which generally is a static list and suffers from the aforementioned disadvantages.

U.S. App. No. 20070130126 to Lucovsky et al. published on Jun. 7, 2007 describes an interface for composition of text wherein a search query is generated based on the text, and selections of the search results, which can include advertisements, are associated with the text. Such an interface does not provide an algorithm for determining which advertisements, if any, are associated with the text.

U.S. Pat. No. 6,978,263 to Soulanille on Dec. 20, 2005 describes methods and systems for providing advertisements over the internet by providing a search list in response to a search request. The search list includes search listings that match the search request, and each search listing is associated with an advertiser and a bid amount. The matching advertisers with the highest bid amounts are selected for display, and are arranged in a random order as the search result list. While appearing to provide a dynamic list of advertisers in response to each search query, this is not the case because in order to appear on the search result list, a search listing must have one of the highest bids among all of the matching advertisers. Therefore, for a given search query, the same advertisers will always appear and the list is therefore static, merely changing in order for every given search.

U.S. Pat. No. 6,907,566 to McElfresh et al. on Jun. 14, 2005 describes methods and systems for placement of graphical objects (e.g., advertisements on a web page) on a page to optimize the occurrence of an event (e.g., a user clicking on the advertisements) associated with such objects. A server determines the likelihood of a user clicking on the advertisements based upon past performance (e.g., the web content viewed by a user and the past performance of the advertisement) and arranges the advertisements depending upon this calculation before presenting them to the user. However, to make this calculation, a cookie is generated and maintained on a user's hard disk. Cookies can slow the performance of the user's computer, and users frequently disallow or remove cookies using specialized software. Furthermore, maintaining information about the past performance of every advertisement can require a large data storage capacity, which can be expensive. Additionally, such a method does not ensure that a change in the advertisements presented to a user will ever be changed. As such changes are predicated on change of user activity or performance of an advertisement, they cannot be predicted with the same accuracy as using an algorithm can be.

U.S. Pat. No. 6,826,572 to Colace et al. on Nov. 30, 2004 describes a system for advertisers to manage search listings in a placement database search system, by using grouping means for managing multiple advertiser-created categories for the search listings and query means for searching search listings. Such a system, however, does not provide a dynamic list of advertisements in response to a user search query.

U.S. Pat. No. 6,778,975 to Anick et al. on Aug. 17, 2004 describes a search engine that identifies one or more documents as part of a search using a client's search query terms. The documents are associated with categories, each category having a group of messages associated thereto (e.g., online advertisements). A category is probabilistically selected, and one or more messages are returned on the search result web page. For each search, there is a chance a different category may be selected, thereby providing a different set of results. However, for each category, the messages posted are on a static priority list based upon bid amount. Therefore, advertisers can purchase the highest bid for a group of categories, and therefore limit the number of advertisements shown on a search result web page.

Therefore, there is a need for a method that provides an algorithm for providing a dynamic list of advertisements responsive to a search query. Furthermore, the algorithm would be predictable and would vary the frequency that the ads are presented. Such a method would further allow advertisements with a low position to be displayed at least some of the time, even if the bids for such advertisements were lower than would normally be displayed. The present invention accomplishes these objectives.

### SUMMARY OF THE INVENTION

The present invention is a method of generating a search result list in response to a search request from a client using a computer network. The method includes maintaining a database of a plurality N of network information provider accounts, each account including at least one search term, each search term associated with at least a network address, a modifiable bid value corresponding to a maximum monetary amount that is deducted from the account upon receipt of a retrieval request for the network address, and a position value initially set to the bid value. A search request is received from the client, and a set N_{c} of all possible display candidates of all network addresses associated with search terms generating a match with the search request is identified. The set N_{c} is ordered in accordance with the values of the respective position values.

A display set N_{d} of up to a predetermined maximum display number m of network addresses, and an excluded set Nₑ of those network addresses included in N_{c} but excluded from N_{d} are determined, and display set N_{d} is sent to the client. The position value associated with each of the network addresses in the display set N_{d} is reset to its associated bid amount, and the position value associated with each of the network addresses in the excluded set Nₑ is incremented by an increment factor I determined by at least the bid amount of the network address associated with the minimum position value of the display set N_{d}. A retrieval request is received from the client to retrieve information associated with a network address in the display set N_{d}, and a retrieval request event including account identification information corresponding to the network information provider, is retrieved to permit maintenance of accurate account debit records.

In one embodiment, the increment factor I is determined by dividing the difference between the bid amount associated with the network address having the maximum position value of the excluded set Nₑ and the bid amount associated with the network address having the minimum position value of the display set N_{d} by the number of network addresses in the excluded set Nₑ.

Preferably, a network information provider's account in the database of accounts is updated in response to a request from the network information provider. If the bid value for a search term is modified by the network information provider, the position value for the search term is preferably reset to the bid value.

The present invention includes an algorithm for providing a dynamic list of advertisements responsive to a search query. Furthermore, the present invention varies the frequency that the ads are presented, as opposed to simply the position of the ads on the displayed list of ads. The present method further allows advertisements with a low position to be displayed at least some of the time, even if the bids for such advertisements are lower than would normally be displayed with conventional methods. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a diagram illustrating an exemplary embodiment of an ad placement method with frequency component;

FIG. 2A is a diagram illustrating an exemplary embodiment of a web page that includes a search result list;

FIG. 2B is a diagram of an exemplary embodiment of a set N_{c} of all possible display candidates of all network addresses associated with search terms generating a match with the search request; and

FIG. 3 is a flow-chart of the steps of the method of the present invention.

### DETAILED DESCRIPTION OF THE PREFERRED EMBODIMENT

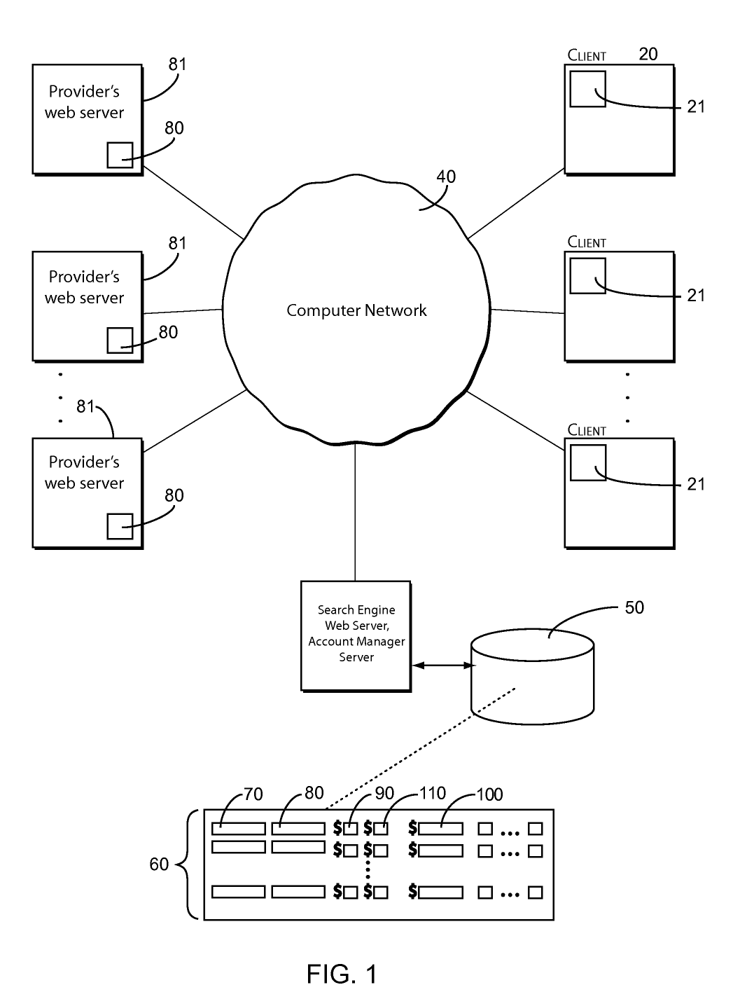

FIG. 1 is a diagram illustrating an exemplary embodiment of an advertisement placement method with a frequency component that generates a search result list in response to a search request from a client 20 using a computer network 40. The search request includes any search query, such as a text query, that is typically entered into a search engine, for example. The search result list includes display candidates 120 (e.g., content matching the search query) found using the computer network 40. The search engine, as shown in FIG. 1, may be located on a server 55 along with a web server and an account management server for managing network information provider accounts 60. The client 20 is physically separated from the server 55, in most cases, but is in communication with the server 55 using the computer network 40. As shown in FIG. 1, there may be a plurality of clients 20. Each client 20 includes a client browser 21, for example. Using the client browser 21, a user sends search requests to the server 55. The computer network 40 can be any suitable network configuration, including the internet.

The present method includes maintaining a database 50 of a plurality N of network information provider accounts 60, each account including at least one search term 70, each search term associated with at least a network address 80, a modifiable bid value 90 corresponding to a maximum monetary amount that is deducted from an account balance 100 upon receipt of a retrieval request for the network address 80, and a position value 110 initially set to the bid value 90. The database 50 stores network information provider account 60 information and can be any known suitable database or file storage system. In one embodiment, the network information providers may store the content of their advertisements, which at a minimum include a web link or pointer to network address 80. In another embodiment, the party maintaining the database 50 uses templates or html forms to generate, manually or automatically, an advertisement allowing the client 20 to make a retrieval request for the network address 80. In an exemplary embodiment, network address 80 direct the client 20 to the provider's web server 81 when selected from within the client browser 21. In another embodiment, network address 80 directs the client 20 to a web site address 80 of the network information provider's choice.

The modifiable bid value 90 functions as described hereinabove, and is modifiable in one embodiment by either the party maintaining the database 50 or by the network information provider. The account balance 100 is the amount of money or currency deposited by the network information provider with the party maintaining the database 50. Alternately, the account balance 100 may be an amount the network information provider is obligated to pay to the partying maintaining the database 50 when invoiced, for example.

When a retrieval request for the network address 80 is received, the account balance 100 can be decreased by the modifiable bid value 90, and the modifiable bid value 90 can be transferred to the party maintaining the database 50. In one embodiment, both the modifiable bid amount 90 and the account balance 100 can be US dollar values.

The position value 110 may be used to determine whether or not the network address 80 is sent to the client 20. The position value 110 may be updated each time a network address is selected as a possible display candidate. In an exemplary embodiment, position value 110 is a dollar value, as shown in FIG. 1, derived at least in part from the bid value 90. Position value 110 is initially set to the bid value 90.

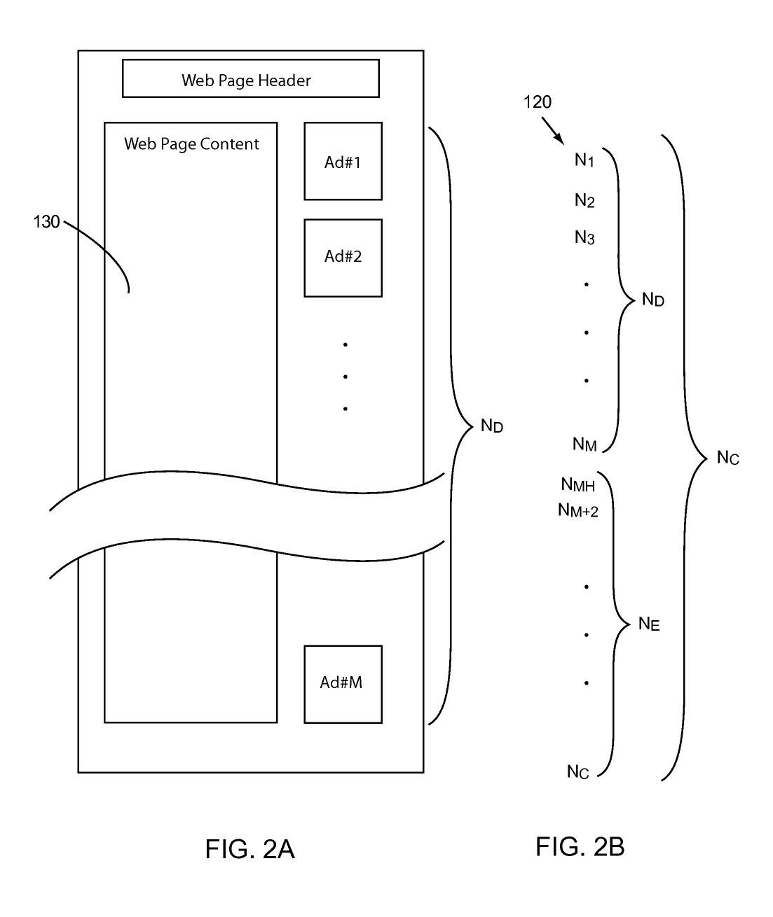

A search request can be received from the client 20, and a set N_{c} of all possible display candidates 120 of all network addresses 80 associated with search terms 70 generating a match with the search request is identified. The set N_{c} is ordered in accordance with the values of the respective position values 110 as is shown in FIGS. 2A & 2B. The search engine can determine that the search terms match the search request using any known suitable matching method or process.

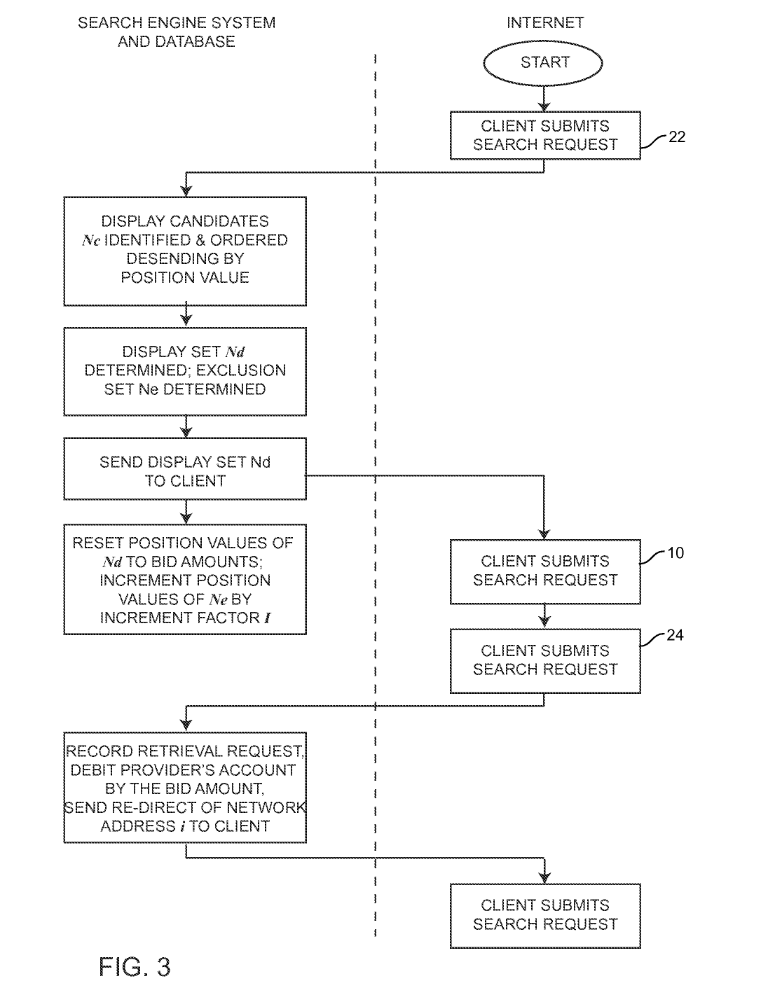

A display set N_{d} of up to a predetermined maximum display number m of network addresses, and an excluded set Nₑ of those network addresses included in N_{c} but excluded from N_{d} are determined. As shown in FIG. 2B, display set N_{d} includes network addresses N₁, N₂, N₃ . . . Nₘ. The remaining network addresses, including network addresses Nₘ₊₁, Nₘ₊₂ . . . N_{c}, are included in the excluded set Nₑ. The display set N_{d} is sent to the client 20, as shown in FIGS. 2A and 3. FIG. 2A includes an exemplary embodiment of a web page that includes any web page content 130 and the display set N_{d}. The network addresses 80 included within the display set N_{d} are displayed as, in this example, banner ads as shown in FIG. 2A, but may be formatted in any other way as desired by the operator of the server 55 or the network information providers.

The position value 110 associated with each of the network addresses 80 in the display set N_{d} is then reset to its associated bid amount 90, and the position value 110 associated with each of the network addresses 80 in the excluded set Nₑ is incremented by an increment factor I determined by at least the bid amount 90 of the network address 80 associated with the minimum position value 110 of the display set N_{d}. In the exemplary embodiment shown in FIG. 2B, the minimum position value 110 of the display set N_{d} is the position value 110 of the network address Nₘ.

This step can be repeated, and increment factor I can be used to increase the position value 110 of the network addresses 80 in the excluded set Nₑ until the position value 110 of the highest position value 110 of the excluded set Nₑ (i.e., Nₘ₊₁) exceeds the minimum position value 110 of the display set N_{d}. When this occurs, the network addresses 80 in the display set N_{d} are changed to account for the new position values 110, and the displayed banner ads and network addresses 80 are changed accordingly. A dynamic list of ads and network addresses 80 are therefore provided in accordance with the principles of the present invention.

Returning to FIGS. 1 and 3, when a retrieval request is received from the client 20 to retrieve information associated with a network address 80 in the display set N_{d}, a retrieval request event including account identification information corresponding to the network information provider 80 is recorded to permit maintenance of accurate account debit records in the database 50, as is known in the art.

In one embodiment, the increment factor I is determined by calculating the difference between A) the bid value 90 associated with the network address having the maximum position value 110 of the excluded set Nₑ (e.g., Nₘ₊₁), and B) the bid amount 90 associated with the network address 80 having the minimum position value 110 of the display set N_{d} (e.g., Nₘ), and dividing by the number of network addresses 80 in the excluded set Nₑ.

Preferably, a network information provider's account 60 in the database 50 may be updated in response to a request from the network information provider. If the bid value 90 for a search term is modified by the network information provider, the position value 110 for the search term is preferably reset to the bid value 90.

While a particular form of the invention has been illustrated and described, it will be apparent that various modifications can be made without departing from the spirit and scope of the invention. For example, multiple servers 55 can be used to host the search engine, web server, and account management server functions instead of a single server 55. Accordingly, it is not intended that the invention be limited, except as by the appended claims.

What is claimed is:

1. A method of generating a search result list in response to a search request from a client using a computer network, comprising:
a) maintaining a database of a plurality N of network information provider accounts, each account including at least one search term, each search term associated with at least a network address, a modifiable bid value corresponding to a maximum monetary amount that is deducted from the account upon receipt of a retrieval request for the network address, and a position value initially set to the bid value;
b) receiving a search request from the client;
c) identifying a set N_{c} of all possible display candidates of all network addresses associated with search terms generating a match with the search request, and ordering the set N_{c} in accordance with the values of the respective position values;
d) determining a display set N_{d} of up to a predetermined maximum display number m of network addresses, and an excluded set Nₑ of those network addresses included in N_{c} but excluded from N_{d}, and sending the display set N_{d} to the client;
e) resetting the position value associated with each of the network addresses in the display set N_{d} to its associated bid amount, and incrementing the position value associated with each of the network addresses in the excluded set Nₑ by an increment factor I determined by at least the bid amount of the network address associated with the minimum position value of the display set N_{d};
f) receiving a retrieval request from the client to retrieve information associated with a network address in the display set N_{d}; and
g) recording a retrieval request event including account identification information corresponding to the network information provider, to permit maintenance of accurate account debit records.

2. The method of claim 1 wherein the increment factor I is determined by dividing the difference between the bid amount associated with the network address having the maximum position value of the excluded set Nₑ and the bid amount associated with the network address having the minimum position value of the display set N_{d} by the number of network addresses in the excluded set Nₑ.

3. The method of claim 1 further including the step of h) updating a network information provider's account in the database of accounts in response to a request from the network information provider, and if the bid value for a search term is modified by the network information provider, resetting the position value for the search term to the bid value.
